(19) United States
(12) Patent Application Publication
(10) Pub. No.: US 2009/0282099 A1
(43) Pub. Date: Nov. 12, 2009

(54) SECURE DISTRIBUTED MULTIHEAD TECHNOLOGY

(75) Inventor: Gideon Z. Romm, White Plains, NY (US)

Correspondence Address: Gideon Z. Romm, Symbio Technologies, 134 North Avenue, Suite E, New Rochelle, NY, 10801, US

(73) Assignee: SYMBIO TECHNOLOGIES, LLC, New Rochelle, NY (US)

(21) Appl. No.: 12/464,019

(22) Filed: May 11, 2009

Related U.S. Application Data
(60) Provisional application No. 61/051,982, filed on May 9, 2008.

(51) Int. Cl. G06F 15/16

(52) U.S. Cl. 709/203; 709/201; 709/231; 709/208

(57) ABSTRACT

Systems and methods for securing display information in distributed multihead computer systems are provided. The display information is generated by a display composition engine from inputs from application data streams and an input data stream. Techniques for electrically isolating display data streams from shared networks are provided. Techniques for configuring a secure distributed multihead system are provided.

### CROSS-REFERENCE

This claims the benefit under 35 U.S.C. §119(e) of U.S. Provisional Application No. 61/051,982, filed May 9, 2008, which is hereby incorporated herein by reference in its entirety.

### BACKGROUND

In many environments, computer users would like to work on a desktop display that spans multiple monitors, in effect combining a number of individual displays into one large display. With such a computer setup, a user can have a much larger display area upon which to view multiple applications at the same time, or upon which to view a large amount of information from a single application. For example, a user whose primary task is data entry may have a database application open into which they are continuously entering data, while at the same time have the original source of that data open in another application on another monitor. The user's productivity is thus increased dramatically with the ability to view all the information at the same time without the need to constantly switch between the original source of the data and the database application.

When a single computer is able to connect to multiple monitors at the same time, this is commonly referred to as a “multihead” computer system, with the monitors referred to as the computer system's “head”. The most common way of implementing a multihead computer system is using a single computer with multiple video cards—or a single video card with multiple ports—each attached to a monitor. The computer system is then configured to treat the multitude of monitors as one large display or as a series of related displays, caring for the position of the mouse, keyboard input, and application windows within the displays.

For computer systems that can support multiple video cards, this approach works quite well. However, for computer systems with limited or no expansions capabilities, a different approach may be necessary to achieve a multihead computer system. In such an environment, multiple computer systems, each of which is connected to a single monitor, may be connected together. This type of multihead computer system may be referred to herein as a distributed multihead computer system. One of the computer systems connected together to form the distributed multihead computer system coordinates the display on each of the other computer systems. This approach makes little sense in an environment with computer systems that can be expanded to support multiple displays, because this would result in an enormous increase in power consumption and overhead to achieve what could be otherwise achieved with a single system and multiple video cards. However, in an environment in which many small, low-powered, silent machines are used, the difference in power consumption can be negligible. Moreover, a distributed multihead computer system offers a great deal of flexibility, because the individual computer systems can be combined or separated easily depending upon the multihead needs of the organization, and can be easily redeployed in different ways as needs change.

One issue arises, however, with the communication of video information between the multiple computer systems in the distributed multihead system: securing the display information. Display information will be carried by packets across the network connection between the computers. If those packets are not secured in some way, the information they contain can be reconstructed to recreate either the display or perhaps even the input information. There is a need in such an environment for a solution that will protect the display information from being able to be collected over the network and being compromised.

### SUMMARY

The word “network” is used in the present invention to be a group of nodes (e.g. computing devices, servers, appliances, storage devices, printers, etc.) connected together using physical and electronic interconnections such that each node is connected to at least one other node either directly or through intermediate links and/or devices, with all nodes complying with certain pre-agreed upon rules, generally known as “protocols”. A participant node in the network can transfer information to other nodes in the network by complying with network protocols. The connection between source and target generally passes through other participant nodes in the network which route the information to the destination.

The term “private communication link” is used in the present invention to refer to a connection between a group of computing devices that is shared only between those computing devices and not with the network at large. That is, any communication that goes across such a connection is only transferred between those computing devices and does not go through the network that is used to communicate with other devices. The connection between the computing devices that make up the secure distributed multihead system may be isolated from the network that connects them to all the other nodes in the environment. This eliminates the ability for another node in the environment to collect display information traveling between the computing devices in the distributed multihead system. Moreover, using the private communications link keeps the display information secure without introducing additional software overhead, such as encryption techniques that may otherwise degrade the video performance. In some embodiments, a USB Host-to-Host adapter cable may be used to create the private communication link between the computers.

In some embodiments, the computing devices may be thin client devices that receive one or more application data streams from an application server on the network and simply display a desktop that is provided by the application server that spans across multiple monitors. In such environments, where interconnectivity between the computing devices and a server is a necessity, the need to secure the display information in a distributed multihead system is great.

In some embodiments, the thin client devices may connect to multiple application servers simultaneously and receive multiple simultaneous application data streams. In one configuration, a different application data stream may be displayed on each monitor in the secure distributed multihead system. All of the application data streams may be controlled using a single collection of input devices for all desktops displayed in the secure distributed multihead system. It should be noted that while the term “desktop” is used here, more generally, an application server can provide desktops or individual applications, and a “desktop” may be considered an example of an application.

Various advantages and features of the present invention will become more readily apparent to those skilled in the art from the following description thereof, especially when taken in conjunction with the following drawings.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 shows an illustrative secure distributed multihead system in accordance with an embodiment;

FIG. 2 shows an illustrative application server environment in which multiple secure distributed multihead systems are connected over a shared network to an application server in accordance with an embodiment;

FIG. 3A shows an illustrative block diagram of a single application data stream and input device data stream as inputs to a display composition engine in accordance with an embodiment;

FIG. 3B shows an illustrative block diagram of multiple application data streams and a single input device data stream as inputs to a display composition engine in accordance with an embodiment;

FIG. 4A shows an illustrative single desktop that spans multiple monitors in accordance with an embodiment;

FIG. 4B shows an illustrative example of a desktop display of FIG. 4A in accordance with an embodiment;

FIG. 5A shows an illustrative multiple independent desktop display across two monitors in accordance with an embodiment; and

FIG. 5B shows an illustrative example of a desktop display of FIG. 5A in accordance with an embodiment.

### DETAILED DESCRIPTION

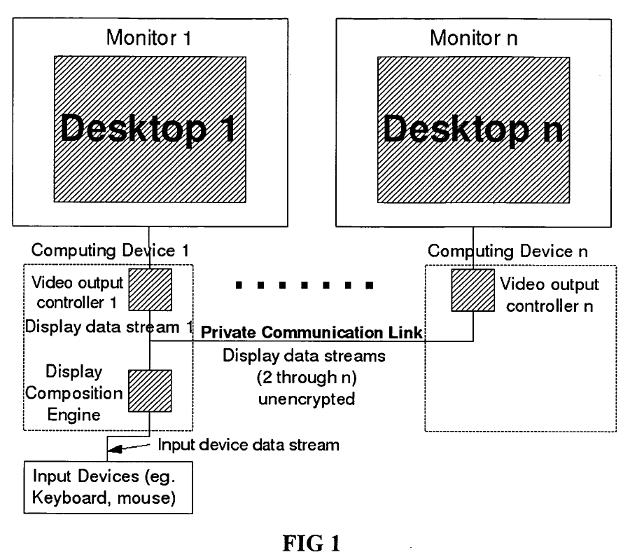

FIG. 1 illustrates the flow of data in a secure distributed multihead system. The secure distributed multihead system includes multiple computing devices (i.e., computing devices 1 through n). Each of the computing devices has a video output controller. The video output controller of each computing device generates a display output that is connected to a display device (e.g., a monitor). The term “screen” is used to refer to the area of pixels on the display device that displays an image. As used herein, a computing device may be defined as any system with a CPU and video output (e.g., a computer, a thin client, a cell phone, etc). A video output controller may be defined as a piece of software or hardware whose role in the system is to control the video output to the monitor. When there is a piece of software that is used in combination with a piece of hardware to control the video output, then the combined software/hardware combination may be considered the video output controller. A display may be defined as the composition of elements that are to be drawn on the display devices (e.g., monitors). A “desktop” or “desktop display” refers to a portion of the display that is used by the user to arrange graphical elements. A “coordinated display area” is defined as the composite of all displays on all monitors in the distributed multihead system. For example, if there are three monitors in the multihead system and one display spans monitors 1 and 2 and a second display is on monitor 3, the entire area starting at the top left corner of monitor 1 and ending at the bottom right corner of monitor 3 is considered the “coordinated display area”. The multiple monitors of the computing devices may provide a multihead display using the multiple computing devices. A private communication link is connected between the multiple computing devices in order to generate the multihead display of the secure distributed multihead system. The private communication link will be described in greater detail below.

Computing device 1 of the secure distributed multihead system includes a display composition engine. As will be described in greater detail below, the display composition engine may send and receive data over the private communication link to control of the generation of a multihead display. The computing device (i.e., computing device 1) that includes the display composition engine may communicate with the video output controllers of the other computing devices in the distributed multihead system to generate the multihead display. The display composition engine may be a software module operating one or more of the computing devices in the secure distributed multihead system and may be used to generate a multihead display using the multiple computing devices. It should be understood that any of the n computing devices may be used to control a multihead display using a display composition engine. Furthermore, each of the computing devices may be capable of controlling any of the other n computing devices using a display composition engine, depending on the configuration of the secure distributed multihead system. For ease of illustration and not by way of limitation, computing device 1 is illustrated as having the display composition engine to control the multihead display while computing device n is illustrated without a display composition engine. The computing device that includes the display composition engine may be referred to as the “master” computing device, with all other computing devices contained within the secure distributed multihead system referred to as “slave” computing devices.

As illustrated in FIG. 1, the secure distributed multihead system may be controlled by a set of input devices. All of the input devices that are used to control the secure distributed multihead system may be referred to as the set of input devices. For example, the set of input devices may include one or more keyboards, mice, touchpads, tablets, touchscreens, etc. While each of the computing devices in the secure distributed multihead system may be able receive user inputs from various input devices, for ease of illustration all of the input devices in FIG. 1 are connected to computing device 1 and are received by the display composition engine. However, it should be understood that one or more of the input devices may be connected to other computing devices. In such a configuration, input device data streams may be communicated to the display composition engine from these other computing devices over the private communications link.

The input device data stream includes all of the input data information from the set of input devices that serve as input to the display composition engine running on computing device 1. The display composition engine also receives input data information from one or more application data streams (not shown) to compose a display to be rendered by the distributed multihead system. By application data stream, what is meant is the display information generated by a computer program that is normally sent to the video controller. This application data stream may come from a single application running on the same computing device as the video controller or it may be transmitted over a network from an application running on a different computing device as the video controller. Moreover, multiple application data streams generated by multiple independent applications may be sent to a video controller that resides on the same computing device as the multiple applications or on a different computing device, and the multiple applications may reside on the same computing device or on different computing device or on some combination thereof. For example, a user may work on a Windows desktop application data stream coming from one application server and a Linux desktop application data stream coming from another application server at the same time. Alternatively, a user may work on a Windows desktop provided by an application server in one domain with a low level of security and a second Windows desktop in a domain with a high level of security and the information is meant to be isolated between one domain and the other. This may be advantageous in environments in which users access different application servers from networks with varying levels of security information, and it is important that the user be able to work on all systems simultaneously but not be able to transfer information from one system to the other.

A display data stream is output from the display composition engine and may be supplied to the video output controllers running on computing device 1 and all other n computing devices in the secure distributed multihead system. The display data stream may be provided directly from the display composition engine to the video output controller of computing device 1. The display data streams for the other computing devices in the secure distributed multihead system may be transmitted over the private communication link. Each video output controller running on each individual computing device may then send a video output signal to its respective monitor to generate the multihead display.

Any suitable protocol may be used to transmit display information as part of the display data streams. For the remainder of this description, it will be presumed, for simplicity, that the protocol used to transmit display information between computing devices is an X11 protocol, but it should be understood that the display data stream may use other types of protocols and that these protocols may or may not have security mechanisms built into them. The X11 protocol is a client-server display protocol, in which applications that would like to display graphical elements on a computer monitor act as X11 clients that make a request to an XII server. The X11 server is a piece of software that runs on the computer whose video card will drive the monitor and therefore present the display on the monitor. This communication is “network transparent”, meaning that applications that reside on one computer can display output on a second computer by making a request to display that information to the second computer's X11 server. In addition, there exists a piece of software called an X11 proxy. An X11 proxy accepts requests to display information from one or more X11 clients. An X11 proxy, however, does not drive a video card nor is it responsible for displaying information on the monitor of any computer. The X11 proxy may manipulate the display requests it receives in some way and then it makes its own requests to one or more X11 servers to create the display on their respective monitors. In short, an X11 proxy acts as an X11 server to the X11 clients and acts as an X11 client to the X11 servers.

Typically, display information is delivered to a video output controller via an internal process, therefore when distributing this information between computing devices to implement a distributed multihead system, security immediately becomes a concern. To address this security concern, one must either add software security mechanisms that add processing and bandwidth overhead to the protocol, or one must physically separate the transmission from any shared communication network that runs the risk of being compromised by other devices that might collect the transmission information. Furthermore, when it comes to display information, the addition of software overhead is not desirable as it may degrade video performance.

However, in many situations where a distributed multihead system may prove useful, there are often no obvious communication links that are not shared with other computers. One example of such an environment is in a thin client environment, in which many computing devices, usually with a single network port for standard Ethernet communications, are connected to a shared Ethernet network to receive application information from an application server connected to the same network. In such an environment, the ability to group several thin clients together for the purpose of creating a distributed multihead system is quite convenient and practical. This flexibility means that the environment can be adapted as needed without the purchase of special hardware. However, if the existing shared Ethernet network is used for the communication of the display information, the security of the user's display information may be compromised. This display data information may be secured on such a system without degrading performance through the use of a private communication link. This private communication link may be connected directly between two computers in the system, with direct links between computers forming a chain, passing the display data stream from one to the next. Alternatively, the private communication links can go into an external hub or switching device that would ensure that the private communication link traffic is transmitted to each member of the distributed multihead system. The important factor here is that the private communication link be “private”, in the sense that it is not shared with any device that is not a member of that distributed multihead system. The private communication link could use any protocol, such as USB, firewire, wifi, Bluetooth, Ethernet, Fibre Channel, SCSI, serial data port, parallel data port, etc. or proprietary protocols.

It may be desirable to select a protocol and connection for the private communication link that has sufficient bandwidth characteristics to support the display protocol information sent across it so as not to degrade the video performance. In the case of X11 display data traffic, up to 100 Mbps of continuous throughput may be required. In some embodiments, a USB 2.0 connection may be used as that private communication link. USB 2.0 ports may be found on most computing devices including thin client systems. USB 2.0 ports are typically used for input devices or external storage devices. A USB 2.0 cable may be used as a private communication link between two computing devices by establishing a direct connection between two computing systems (as opposed to a connection between a computing device and a peripheral). After this connection is established the computing devices may communicate using TCP/IP network packets over a TCP/IP peer-to-peer connection formed between the two computing devices on the USB link. It should be understood that this peer-to-peer connection may use any network protocol, but TCP/IP is chosen here for convenience. Moreover, as indicated above, the private communication link via USB may be a direct peer-to-peer USB connection, may be a chain of USB connections, or may be connections through a USB hub. Since USB 2.0 also has a maximum bandwidth of 400 Mbps, it has sufficient bandwidth so as to not degrade X11 display traffic transmitted over it.

An additional benefit of using a dedicated private communication link rather than a shared network link to communicate the display data streams in the secure distributed multihead system is to maximize the video performance. The bandwidth of a dedicated private communication link is generally not shared with any other communications that may ordinarily traverse the shared network. This can be particularly critical in a thin client environment, in which application data streams are continuously transmitted over the shared network and may otherwise compete with the transmission of display data streams between members of the secure distributed multihead system. The private communication link may be partially or even entirely dedicated to communicating display data streams. Alternatively, the private communication link may prioritize the display data streams over other data.

Moreover, the maximum resolution that can be achieved in a distributed multihead system is often times much greater than that which may be achieved in a non-distributed multihead system. This is because a single video card that controls the display on several monitors often requires an increasingly fast output rate as the number of monitors and resolution increases. However, in a distributed multihead system each computer's video card is responsible for its own display. This means that the output rate of any video card in the system need not increase to achieve a higher aggregate resolution. For example, say the desire is to have four monitors laid out in a row, each with a resolution of 1680×1050 pixels. This would be a combined resolution of 6720×1050. In order for a single video card to draw a display 6720 pixels wide, it may need to achieve an output rate of roughly four times that of a display of 1680×1050. However, in an equivalent distributed multihead system, each individual video card on each individual machine need only achieve an output rate sufficient to display a 1680×1050 display. Therefore, there is no increased burden placed upon the hardware involved. This results in the capability of achieving resolutions much higher than a non-distributed multihead system, simply by adding additional computers to the distributed multihead system.

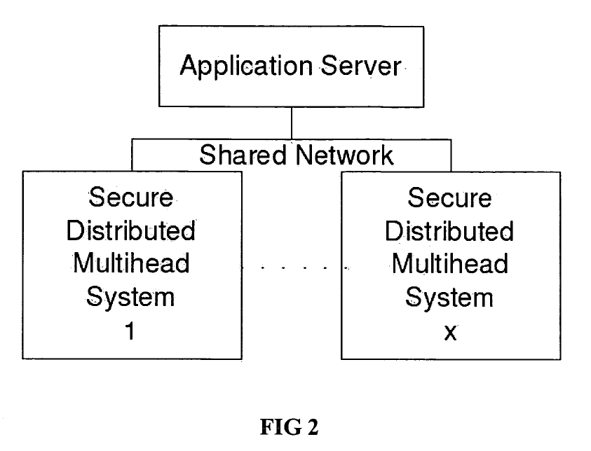

FIG. 2 is an illustration of multiple secure distributed multihead systems sharing a common network. The secure distributed multihead systems may include thin client computing systems in which the common network may be used for communicating to an application server and the private communication links may be used for the display data. It should be noted that even if the computing devices in the secure distributed multihead systems are not thin client computing devices, and receive their application data streams from applications running on one or more computing devices within the secure distributed multihead system itself, they may still have connections to a shared network. In either embodiment, it can be seen that having a private communication link for display information is important for maintaining security.

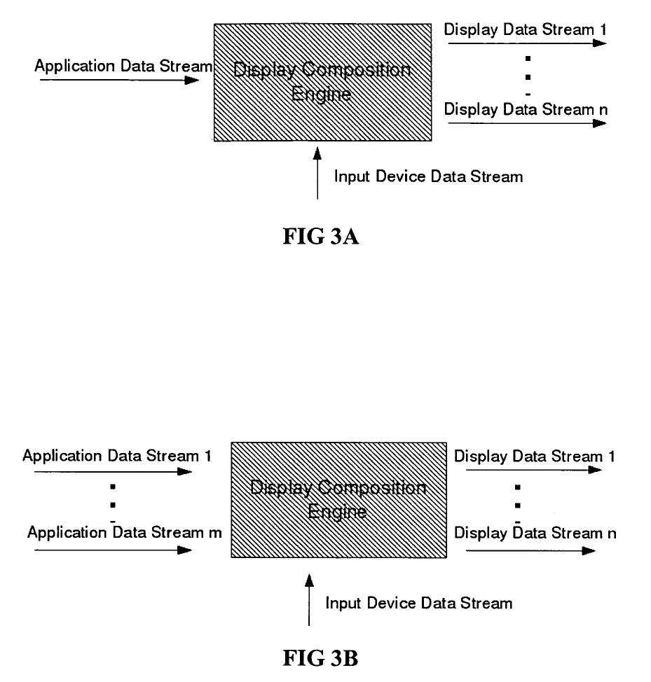

FIG. 3A illustrates the flow of data through a display composition engine. The display composition engine of FIG. 3A may be the same as or similar to the display composition engine in computing device 1 of FIG. 1. The display composition engine receives input from one or more input data streams and one or more application data streams. The display composition engine may use these inputs to compose the display data streams that are sent to the video controllers in the various computing devices. For example, in an X11 system, the display composition engine may be an X11 proxy that receives X11 display information from an X11 client application, compose it into a display that spans across the multiple monitors, and send X11 commands to the individual X11 servers running on each computing device. The X11 traffic sent to X11 servers running on other computing devices in the secure distributed multihead system may be sent over a private communications link, for example, over a direct USB 2.0 connection using Ethernet-over-USB networking protocol.

FIG. 3B illustrates how several independent application data streams can be combined by the display composition engine to create different combinations of desktop displays on the monitors, some of which may span across monitors and some of which may not, but all of which may be controlled by a single collection of input devices. For example, a single distributed multihead system may receive inputs from two applications (i.e., two application data streams), each of which creates a desktop display. As described above, each application data stream may be received from a different server and may be a different operating system or environment. This distributed multihead system may have three monitors connected to three computing devices. The system may be configured such that the desktop display it receives from the first application data stream spans across monitor 1 and monitor 2, such that the top left of the desktop display is on the top left of monitor 1 and the bottom right of the desktop display is at the bottom right of monitor 2. Moreover, the system may be configured such that the desktop display it receives from the second application data stream is displayed on monitor 3, such that the top left of the desktop display is at the top left of monitor 3 and the bottom right of the display is at the bottom right of monitor 3. In this way, monitors 1 and 2 form a single desktop display and monitor 3 forms a separate desktop display. As such, graphical elements from desktop display 1 can be moved from monitor 1 to monitor 2 but not to monitor 3 and graphical elements from monitor 3 cannot be moved to monitor 1 or monitor 2. All graphical elements may be controllable by the same collection of input devices that are attached to the secure distributed multihead system. As will be described in greater detail below, the secure distributed multihead system may be configurable to dynamically change its configuration. For example, the allocation of the application display screens to the monitors may be changed and/or application data streams may be added or subtracted and/or additional computing systems having monitors may be added or subtracted. All of this may preferably be done without significantly interrupting the operations of the various applications.

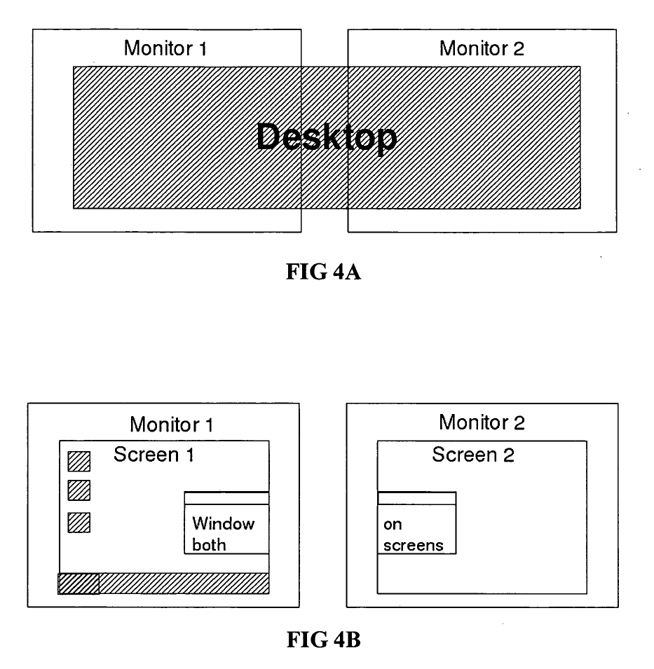

FIG. 4A illustrates what is meant by a desktop display spanning across multiple monitors. From the user's point of view, there is one large desktop. FIG. 4B illustrates how a user may drag a window in a graphical environment off the right edge of the display on screen 1 and the right side of the window would appear on the left side of screen 2. This works because the application is told that the display is the size of the rectangle that starts at the top left corner of screen 1 and ends at the bottom right corner of screen 2. The application then tells the display composition engine to draw the window in the middle of the display. The display composition engine instructs the video controller controlling screen 1 to display the left half of the window and the video controller controlling screen 2 to display the right half of the window. This desktop display is said to “span” across both monitors.

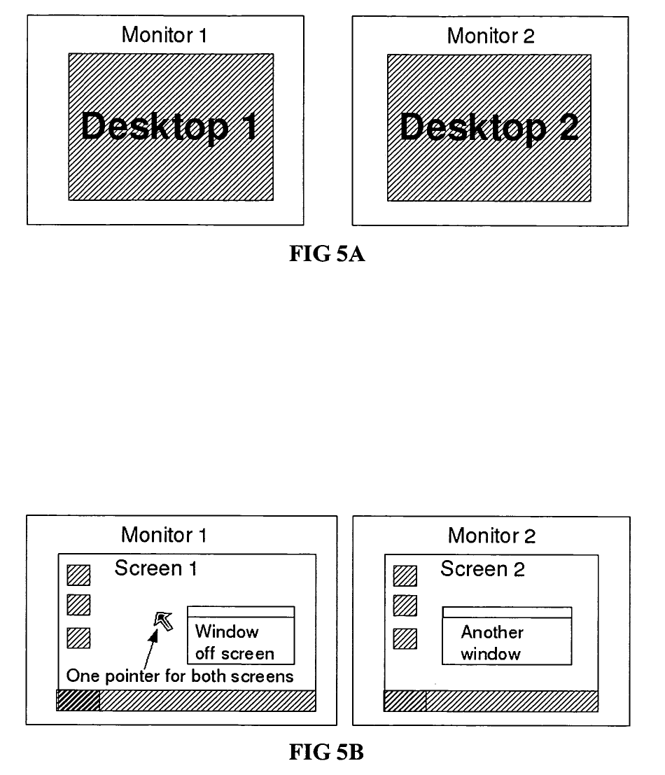

FIG. 5A illustrates how the distributed multihead system may separate multiple application data streams into separate screens, each controlled by the same input devices. FIG. 5B illustrate how two independent desktops may be displayed on two separate screens. When a user drags a window to the right edge of the display on screen 1 in this setup, the left side of the window is not displayed, because it is off the screen. However, if the user moves his mouse pointer off the right side of screen 1, it will appear on screen 2. Then, the user can independently manipulate another window on screen 2 with that same mouse pointer. This works because the display composition engine tells the application providing application data stream 1 that its desktop display is the size of the rectangle beginning at the top left corner of screen 1 and ending at the bottom right corner of screen 1. At the same time, it tells the application providing the application data stream of screen 2 that its desktop display is the size of the rectangle beginning at the top left of screen 2 and ending at the bottom left of screen 2. The display composition engine then composes output display data streams for each video controller. When the user moves the window to the right of screen 1, the display composition engine does not draw the right side of it on screen 2 as in FIG. 4B, rather it is off the displayed area, because screen 2 is reserved for information coming from application data stream 2. However, when the user moves the mouse pointer from screen 1 to screen 2, the display composition engine displays it on screen 2 and the input coming from the input device data stream is transmitted to the application producing application data stream 2 rather than the application producing application data stream 1.

The configuration of the secure multihead system may be determined in several ways. In one embodiment, the configuration may be predetermined by configuration settings that are downloaded to the computing devices from a centralized appliance or server. An appliance is defined as a computer system whose primary function is to care for the configuration and ability of the computing devices to operate as desired. A server is defined as a computer system that performs a variety of tasks that may or may not be related to this system but one of which is to configure the computing devices in each distributed multihead system. In another embodiment, the configuration of each computing device within the distributed multihead system may be predetermined by configuration settings stored on each computing device.

In some embodiments, the user may request a particular change in configuration. This request may be generated by the distributed multihead system and sent to the appliance or server. The appliance or server may then accept or decline the change in configuration. If accepted, the change may be downloaded to the computing devices and implemented without further user intervention. In some embodiments, one ore more of the computing devices may need to be rebooted to implement the accepted configuration changes.

In some embodiments, the multihead configuration may be dynamic. In one embodiment, a user may have the ability to change the configuration while using the station based upon the available computing devices that are detected as being members of the distributed multihead system. For example, when the system powers on, the user may be asked to inform the display composition engine about the configuration of the multihead system, as well as the placement of desktop displays within the multihead system display. Alternatively, a user using the system in one configuration may be prompted to change the configuration upon the connection (or disconnection) of another computing device to the private communication link. That is, the display composition engine would become aware of the addition or deletion of a member of the distributed multihead display and may prompt the user for instructions on how to change the display. Additionally a user may be able to initiate a connection or otherwise access an additional application data stream. Upon receipt of a new application data stream, the display composition engine may reallocate one or more displays to the new application data stream. Similarly, when an application data stream is terminated or disconnected the display composition engine may reallocate one or more displays used by the terminated application data stream to the remaining application data streams.

In another embodiment, the multihead configuration may be smart and dynamic. In this embodiment, no intervention with the user would be required. The display composition would have an initial configuration based upon the number of application data streams it has as input initially and how many computing devices are members of the multihead system. As application data streams are added and removed and as members of the multihead system are added and removed, the display composition engine reconfigures the display according to a built-in set of rules. For example, if initially, there exists one application data stream and two computing devices as members of the secure distributed multihead system, the display is automatically spanned across both monitors at the maximum resolution for each monitor. If an additional application data stream is added that produces an independent desktop display, the display composition engine automatically alters the composition of the display to produce two independent desktop displays on the two monitors in the system. If a third computing device is then added to the multihead system, the display composition engine further alters the display such that one desktop display spans two monitors and the second spans only one monitor. Then, if one of the application data streams is removed and the system has only one desktop display as input, the display composition engine automatically spans the one remaining desktop display across all three monitors in the system.

In the foregoing description, the invention has been described with reference to specific embodiments thereof. It will, however, be evident that various modifications and changes may be made thereto without departing from the broader spirit and scope of the invention. For example, although the invention has been explained showing linkages between two computing devices, the invention can be applied to linkages between three or more computing devices in routine fashion. The specifications and drawings are, accordingly, to be regarded in an illustrative way, rather than in a restrictive sense.

What is claimed is:

1. A secure distributed multihead computing system, comprising:
a first computing device having a display composition engine; and
a private communications link between the first computing device and a second computing device,
wherein the display composition engine is operative to:
generate a first portion of a coordinated display area and a second portion of the coordinated display area,
output a first display data stream indicative of the first portion of the coordinated display area, and
transmit a second display data stream indicative of the second portion of the coordinated display area over the private communication link to the second computing device.

2. The secure distributed multihead computing system of claim 1, further comprising an input device coupled to the first computing device operative to generate an input device data stream, wherein the input device data stream is operative to control the first portion of a coordinated display area and the second portion of the coordinated display area.

3. The secure distributed multihead computing system of claim 1, wherein the private communications link comprises a direct connection.

4. The secure distributed multihead computing system of claim 1, wherein the private communications link comprises a USB connection.

5. The secure distributed multihead computing system of claim 1, further comprising a network connection between the first computing device and a server.

6. A secure distributed multihead computing system, comprising:
a first thin client device having a display composition engine;
a network connection between the first thin client device and an application server; and
a private communications link between the first thin client device and a second thin client device,
wherein the display composition engine is operative to:
receive at least one application data stream from the application server over the network connection,
generate a first portion of a coordinated display area and a second portion of the coordinated display area,
output a first display data stream indicative of the first portion of the coordinated display area, and
transmit a second display data stream indicative of the second portion of the coordinated display area over the private communication link to the second thin client

7. The secure distributed multihead computing system of claim 6, wherein the display composition engine is further operative to:
receive a single application data stream;
generate the first portion of a coordinated display area based on the single application data stream; and
generate the second portion of the coordinated display area based on the single application data stream.

8. The secure distributed multihead computing system of claim 6, wherein the display composition engine is further operative to:
receive a first application data stream and a second application data stream;
generate the first portion of the coordinated display area based on the first application data stream; and
generate the second portion of the coordinated display area based on the second application data stream.

9. The secure distributed multihead computing system of claim 8, wherein the first application data stream and the second application data stream are both received by the first thin client device over the network connection.

10. The secure distributed multihead computing system of claim 8, wherein the first application data stream is received by the first thin client device over the network connection and wherein the second data stream is received by the first thin client device over the private communication link from the second then client device.

11. The secure distributed multihead computing system of claim 8, wherein the first application data stream is a first operating system environment and the second application data stream is a second operating system environment.

12. The secure distributed multihead computing system of claim 6, wherein the display composition engine is further operative to connect to a remote server to receive display composition engine configuration data.

13. The secure distributed multihead computing system of claim 6, further comprising an input device coupled to the first thin client device operative to generate an input device data stream, wherein the input device data stream is operative to control the first display area and the second display area.

14. The secure distributed multihead computing system of claim 6, wherein the private communications link comprises a direct connection.

15. The secure distributed multihead computing system of claim 6, wherein the private communications link comprises a USB connection.

16. A secure distributed multihead computing system, comprising:
a master display computing device having a display composition engine;
an input device coupled to the master display computing device operative to generate an input device data stream;
a network connection operative to couple the master display computing device to at least one application server, wherein the master display computing device is operative to receive at least one application data stream from at least one application server; and
a private communication link operative to couple the master display computing device to at least one slave display computing device, wherein the master display computing device is operative to transmit at least one display data stream over the private communication link to at least one slave display computing device.

17. The secure distributed multihead computing system of claim 16, wherein the display composition engine is operative to generate at least two display data streams of a coordinated display area.

18. The secure distributed multihead computing system of claim 16, wherein the display composition engine is operative to detect an additional application data stream and generate at least one additional display data stream in response to the additional application data stream.

19. The secure distributed multihead computing system of claim 16, wherein the display composition engine is operative to detect an additional slave display computing device and generate an additional display data stream in response to the additional slave display computing device.

20. The secure distributed multihead computing system of claim 16, wherein the display composition engine is further operative to connect to a remote server to receive display composition engine configuration data.
